(19) United States
(12) Patent Application Publication
(10) Pub. No.: US 2024/0132677 A1
(43) Pub. Date: Apr. 25, 2024

(54) SPRAY-DRYING OF SOLID EPOXY OR PHENOXY RESINS

(71) Applicant: Huntsman Advanced Materials Americas LLC, The Woodlands, TX (US)

(72) Inventors: Zach LYLES, The Woodlands, TX (US); James RUSAK, The Woodlands, TX (US); Peter SCHREIBER, The Woodlands, TX (US); Seth TOMASCH, The Woodlands, TX (US)

(21) Appl. No.: 18/035,390

(22) PCT Filed: Nov. 5, 2021
(86) PCT No.: PCT/US2021/058147

§ 371 Date: May 4, 2023

(51) Int. Cl. C08J 3/12

(52) U.S. Cl. CPC C08J 3/122; C08J 2363/00; C08J 2371/12

(57) ABSTRACT

High molecular weight solid epoxy or phenoxy resins are dissolved in a blend of an alcohol solvent and an aprotic solvent. The resulting solution is spray-dried in a closed-cycle spray drier to form a powdered epoxy or phenoxy resin.

### CROSS-REFERENCE TO RELATED APPLICATION

This application claims the benefit of U.S. Provisional Patent Application Ser. No. 63/111,325 filed on Nov. 9, 2020. The content of the aforementioned application is incorporated herein by reference.

### FIELD

The present application relates to the spray-drying of solid epoxy or phenoxy resins. More specifically, a high molecular weight solid epoxy or phenoxy resin is dissolved in a blend of an alcohol solvent and an aprotic solvent, and the resulting solution is spray-dried in a closed-cycle spray drier to form a powdered epoxy or phenoxy resin.

### BACKGROUND

A high molecular weight epoxy or phenoxy resin often is considered a thermoplastic resin, and typically is used in applications such as injection moldings, extrusions, coatings, and adhesives. A common organic solvent for dissolving an epoxy or phenoxy resin is methyl ethyl ketone (MEK). However, an epoxy or phenoxy resin dissolved in MEK does not spray-dry well. Similarly, spray-drying has not worked well in the past with other solid epoxy or phenoxy resin solutions.

Powdered resins have been formed by cryogenically grinding a polymer as an alternative to spray-drying. However, the resulting average particle size is about 200 μm which is substantially larger than desired for a powdered epoxy or phenoxy resin, and the process is energy intensive and expensive.

Typically in practice until now, a high molecular weight epoxy or phenoxy resin has been synthesized in the presence of a solvent, the solution has been washed with water to remove salts formed during the reaction, and the solvent has been removed yielding solid pellets. Removing the solvent has been accomplished by utilizing a thin-film apparatus under high heat and vacuum such as a Filmtruder® apparatus. However, there is a limit to the amount of solvent that can be removed in this way, and the process startup typically has led to initial periods of high color product and charred material that must be treated as scrap. Furthermore, the pellets are less useful than a powdered epoxy or phenoxy resin.

### SUMMARY

The present disclosure generally provides a method of forming a dry powder thermoplastic resin composition by dissolving a solid thermoplastic resin selected from the group consisting of a solid epoxy resin and a solid phenoxy resin in a blend of a protic solvent and an aprotic solvent to form a slurry and spray drying the slurry to form the dry powder thermoplastic resin composition. The present disclosure also provides a dry powder thermoplastic resin composition obtained by the method above, the thermoplastic resin composition containing a plurality of particles selected from epoxy resin particles and phenoxy resin particles having an average particle size of about 150 μm or less. The dry powder thermoplastic resin composition of the present disclosure may be used in, for example, coatings, adhesives, plastics, composites and electronic components.

### BRIEF DESCRIPTION OF THE DRAWING

FIG. 1 is a flow chart illustrating a method of forming a powdered epoxy or phenoxy resin according to an embodiment of the present disclosure; and

FIG. 2 depicts a spray drying apparatus for use in an embodiment of the present disclosure.

### DETAILED DESCRIPTION

The following terms shall have the following meanings:

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary.

In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. By way of example, “a protic solvent” means one protic solvent or more than one protic solvent. The phrases “in one embodiment”, “according to one embodiment” and the like generally mean the particular feature, structure, or characteristic following the phrase is included in at least one embodiment of the present disclosure and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “optional” or “optionally” means that the subsequently described event, circumstance or material may or may not occur or be present, and that the description includes instances where said event, circumstance or material occurs or is present and instances where it does not occur or is not present.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2 weight percent, or less than 1 weight percent, or less than 0.5 weight percent, or less than 0.1 weight percent, or less than 0.05 weight percent, or even less than 0.01 weight percent, based on the total weight of the composition, or that no amount of that particular compound or moiety is present in the respective composition.

The term “dry powder thermoplastic resin composition” typically refers to a composition that is, among other features, characterized by its residual moisture content, which is preferably low enough in order to prevent the formation of aggregates that would reduce or inhibit the flowability of the powder. As used herein, the term “residual moisture content” (or “residual moisture”) refers to the total amount of solvent present in the dry powder thermoplastic resin composition. The total amount of residual moisture may be determined using any suitable method known in the art such as the Karl-Fischer-titrimetric technique or the thermal gravimetric analysis (TGA) method. In one embodiment, the residual moisture content of the dry powder thermoplastic resin composition according to the invention is 10% (w/w) or less, or 9% (w/w) or less, or 8% (w/w) or less, or 7% (w/w) or less, or 6% (w/w) or less, or 5% (w/w) or less, or 4% (w/w) or less, or 3% (w/w) or less, or 2% (w/w) or less, or 1% (w/w) or less, or 0.5% (w/w) or less or even 0.25% (w/w) or less. In a further embodiment, the residual moisture content of the dry powder thermoplastic resin composition is in the range of between about 0.01% (w/w) to about 5% (w/w), or from about 0.01% (w/w) to about 3% (w/w), or from about 0.01% (w/w) to about 2% (w/w), or from about 0.01% (w/w) to about 1.5% (w/w), or from about 0.01% (w/w) to about 1.25% (w/w), or from about 0.01% (w/w) to about 1% (w/w), or from about 0.01% (w/w) to about 0.75% (w/w).

The term “average particle size” as used herein, refers to a particle diameter corresponding to 50% of the particles in a distribution curve in which particles are accumulated in the order of particle diameter from the smallest particle to the largest particle. Here, the total number of accumulated particles is 100%. The average particle size may be measured by methods known to one of ordinary skill in the art. For example, the average particle size may be measured with a particle size analyzer or measured using a transmission electron microscope (TEM) or a scanning electron microscope (SEM) image. As an example of other measuring methods, the average particle size may be measured with a measurement device using dynamic light scattering. According to this method, the number of particles within predetermined size ranges may be counted, and an average particle diameter may be calculated therefrom.

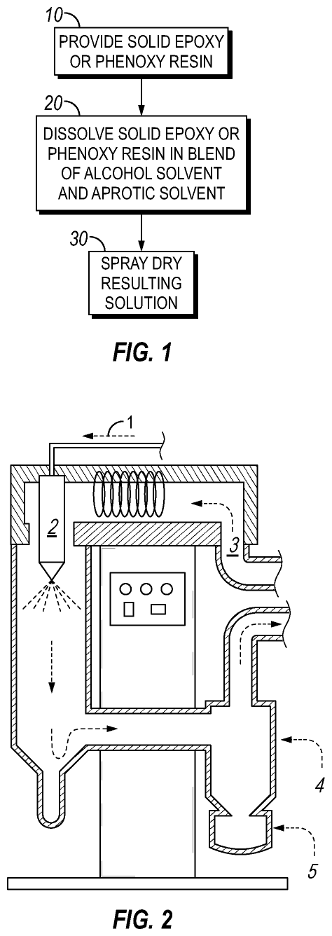

As illustrated in FIG. 1, an exemplary method of forming a powdered epoxy or phenoxy resin comprises providing a solid epoxy or phenoxy resin (10), dissolving the solid epoxy or phenoxy resin in a blend of an alcohol solvent and an aprotic solvent (20), and spray-drying the resulting solution in a closed-cycle spray drier to form the powdered epoxy or phenoxy resin (30).

A closed cycle drier is used in step 30 because an inert atmosphere is desirable due to the atomization of solvent in the drying chamber.

The exemplary method is directed to high molecular weight solid resins with an average molecular weight of at least 1000 Dalton, preferably at least 10,000 Dalton, more preferably at least 30,000 Dalton, more preferably at least 50,000 Dalton, and most preferably between about 50,000 to about 55,000 Dalton.

Molecules of the step 20 alcohol solvent of the exemplary method have two to six carbon atoms. Examples of the alcohol solvent include ethanol, propanol, isopropanol, butanol, pentanol, and hexanol. A preferred alcohol solvent is butanol.

Examples of the step 20 aprotic solvent of the exemplary method include methyl ethyl ketone, methyl isobutyl ketone, toluene, xylene, dichloromethane, and tetrahydrofuran. A preferred aprotic solvent is toluene.

A weight ratio of the alcohol solvent to the aprotic solvent in the step 20 blend of the exemplary method can be, for example, between about 30:70 (w/w) to about 70:30 (w/w), preferably between about 40:60 (w/w) to about 60:40 (w/w), and more preferably about 50:50 (w/w).

The resulting solution in step 20 of the exemplary method contains, for example, between about 1 weight percent to about 10 weight percent epoxy or phenoxy resin, preferably between about 5 weight percent to about 10 weight percent epoxy or phenoxy resin, based on the total weight of the resulting solution.

The powdered epoxy or phenoxy resin resulting from the exemplary method comprises, for example, no more than about 5 weight percent residual solvent, preferably no more than about 1.5 weight percent residual solvent, more preferably no more than about 0.5 weight percent residual solvent, and most preferably no more than about 0.3 weight percent residual solvent, based on the total weight of the powdered epoxy resin or phenoxy resin.

An average particle size of the powdered epoxy or phenoxy resin resulting from the exemplary method is, for example, no more than about 20 μm, and preferably no more than about 12 μm.

As compared to practice typical until now of removing solvent by utilizing a thin-film apparatus under high heat and vacuum, spray-drying allows for lower temperatures to remove solvent because the atomization of the solvent increases the surface area immensely and improves evaporation efficiency. It is believed that the choice of solvent makes a big difference in the ability to spray-dry a solid epoxy or phenoxy resin solution, which has not worked well in the past. Spray-drying an epoxy or phenoxy resin dissolved in a blend of an alcohol solvent and an aprotic solvent allows processing through a spray-drier without “stringing” and produces a powder with a relatively low particle size.

The powdered epoxy or phenoxy resin resulting from the spray-drying step 30 of the exemplary method is very advantageous relative to the pellets resulting from the practice typical until now. Removing solvent by spray-drying reduces the heat exposure as compared to utilizing a thin-film apparatus. This improves quality significantly as black specks and yellow color resulting from the heat exposure no longer form. Furthermore, powdered epoxy or phenoxy resin dissolves faster, than the pellets resulting from the practice typical until now, in, for example, solvents, liquid epoxy resins, amines, acrylates, and polyols. This is a manufacturing convenience and also reduces the cycle time of waterborne and solvent borne derivative production. As a specific example, powdered epoxy or phenoxy resin dissolves almost twice as fast as pellets, with a 40% reduction in derivative production. In addition, the smaller percentage of residual solvent in the powdered epoxy or phenoxy resin reduces concerns about the risk of future regulation in connection with residual solvents, which is a factor in markets such as electronics, composites, and thermoplastic additives.

According to another embodiment, there is provided a method of forming a dry powder thermoplastic resin composition including the steps of dissolving a solid thermoplastic resin selected from the group consisting of a solid epoxy resin and a solid phenoxy resin in a blend of a protic solvent and an aprotic solvent to form a slurry and spray drying the slurry to form the dry powder thermoplastic resin composition. The method according to the invention may be carried out in bulk or as a continuous process. In one embodiment, the method is carried out as a continuous process.

In an embodiment, the solid thermoplastic resin is a solid epoxy resin. The solid epoxy resin may be in a solid state or a semi-solid state at room temperature (25° C.), and may soften when the temperature rises, but does not demonstrate a rapid drop in viscosity. In one embodiment, the molecular weight of the solid epoxy resin may be about 1000 g/mol or more, or about 2000 g/mol or more, or about 5000 g/mol or more, or about 10,000 g/mol or more. In another embodiment, the solid epoxy resin may have a molecular weight of about 60,000 g/mol or less, or about 50,000 g/mol or less, or about 40,000 g/mol or less, or about 30,000 g/mol or less. In still another embodiment, the solid epoxy resin may have a molecular weight of between about 1000 g/mol to about 55,000 g/mol, or between about 2500 g/mol to about 45,000 g/mol, or between about 5000 g/mol to about 35,000 g/mol, or between about 10,000 g/mol to about 25,000 g/mol.

In still another embodiment, the solid epoxy resin may have an epoxy equivalent weight (EEW) of between about 250 g/eq to about 3000 g/eq, or between about 300 g/eq or about 2000 g/eq, or between about 325 g/eq to about 1500 g/eq, or between about 350 g/eq to about 1200 g/eq, or between about 360 g/eq to about 1100 g/eq, or between about 500 g/eq to about 1000 g/eq. In other embodiments, the softening point of the solid epoxy resin at room temperature may be between about 40° C.-120° C., or between about 50° C.-110° C., or between about 60° C.-100° C.

Various solid epoxy resins may be used without particular limitation as long as they are solid or semi-solid at room temperature. Examples include, but are not limited to, bisphenol A epoxy resins, bisphenol F epoxy resins, bisphenol AF based epoxy resins, o-cresol novolak epoxy resins, phenol novolak epoxy resins, modified phenol epoxy resins, naphthalene epoxy resins, triphenolmethane epoxy resins, alkyl modified triphenolmethane epoxy resins, triazine nucleus-containing epoxy resins, dicyclopentadiene epoxy resins, glycidylamine epoxy resins, biphenyl epoxy resins, biphenylaralkyl epoxy resins, hydrogenated bisphenol A epoxy resins, aliphatic epoxy resins, stilbene epoxy resins, triglycidyl ether of trisphenol-methane, isocyanate-modified bisphenol A based epoxy resins, isocyanate-modified bisphenol F based epoxy resins, isocyanate modified bisphenol AF based epoxy resins and bisphenol A novolak epoxy resins, bisphenol F novolak epoxy resins or bisphenol AF novolak epoxy resins.

In another embodiment, the solid thermoplastic resin is a solid phenoxy resin. The solid phenoxy resin may be obtained by a condensation reaction between a dihydric phenol compound and epichlorohydrin, or a polyaddition reaction between a dihydric phenol compound and a difunctional epoxy resin.

Examples of the dihydric phenol compound used for producing the solid phenoxy resin include hydroquinone, resorcin, 4,4-dihydroxybiphenyl, 4,4′-dihydroxydiphenyl ketone, 2,2-bis(4-hydroxyphenyl)propane, 1,1-bis(4-hydroxyphenyl)cyclohexane, 1,1-bis(4-hydroxyphenyl)-3,3,5-trimethylcyclohexane, bis(4-hydroxyphenyl)methane, 1,1-bis(4-hydroxyphenyl)ethane, 2,2-bis(4-hydroxyphenyl)butane, 1,1-bis(4-hydroxyphenyl)-1-phenylethane, bis(4-hydroxyphenyl)diphenylmethane, 2,2-bis(4-hydroxy-3-methylphenyl)propane, 2,2-bis(3-phenyl- 4-hydroxyphenyl)propane, 2,2-bis(4-hydroxy-3-tert-butylphenyl)propane, 1,3-bis(2-(4-hydroxyphenyl)propyl)benzene, 1,4-bis(2-(4-hydroxyphenyl)propyl)benzene, 2,2-bis(4-hydroxyphenyl)-1,1,1-3,3,3-hexafluoropropane, 9,9′-bis(4-hydroxyphenyl)fluorene and the like can be mentioned. Among these, 4,4-dihydroxybiphenyl, 4,4′-dihydroxydiphenyl ketone, 2,2-bis(4-hydroxyphenyl)propane, or 9,9′-bis(4-hydroxyphenyl) are particularly preferable.

The bifunctional epoxy resins used for producing the solid phenoxy resin include epoxy oligomers obtained by the condensation reaction of the above dihydric phenol compound and epichlorohydrin, for example, hydroquinone diglycidyl ether, resorcin diglycidyl ether, bisphenol. S type epoxy resin, bisphenol A type epoxy resin, bisphenol F type epoxy resin, methylhydroquinone diglycidyl ether, chlorohydroquinone diglycidyl ether, 4,4′-dihydroxydiphenyl oxide diglycidyl ether, 2,6-dihydroxynaphthalene diglycidyl ether, dichlorobisphenol A diglycidyl ether, tetrabromobisphenol A type epoxy resin, 9,9′-bis(4)-hydroxyphenyl) full orange glycidyl ether, and the like. Among these, bisphenol A type epoxy resin, bisphenol S type epoxy resin, hydroquinone diglycidyl ether, bisphenol F type epoxy resin, tetrabromobisphenol A type epoxy resin, or 9,9′-bis(4)-Hydroxyphenyl) full orange glycidyl ether are preferred.

The production of the solid phenoxy resin may be carried out without a solvent or in the presence of a reaction solvent, and the reaction solvent used may be, for example, an organic solvent such as methyl ethyl ketone, dioxane, tetrahydrofuran, acetophenone, N-methylpyrrolidone., dimethyl sulfoxide, N,N-dimethylacetamide, sulfolane, toluene and the like. The phenoxy resin obtained using the reaction solvent may be made into a solid resin containing no reaction solvent by subjecting the phenoxy resin obtained to a solvent removal treatment using an evaporator or the like. In other embodiments, the reaction solvent is not removed, but instead is used as part of the blend that is subsequently spray-dried.

The average molecular weight (g/mol) of the solid phenoxy resin may be about 1000 or more, or about 5000 or more, or about 10,000 or more. In other embodiments, the average molecular weight of the solid phenoxy resin may be about 500,000 or less, or about 200,000 or less, or about 150,000 or less or about 100,000 or less. In still other embodiments, the average molecular weight (g/mol) of the solid epoxy resin may be between about 10,000 to about 250,000, or between about 20,000 to about 150,000, or between about 25,000 to about 80,000.

In another embodiment, the hydroxyl group equivalent (g/eq) of the solid phenoxy may be between about 50 to about 1,000 or between about 100 to about 750, or between about 200 to about 500.

According to another embodiment, the solid phenoxy resin may have a structural formula

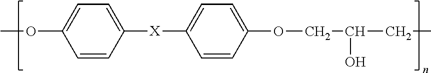

where n is an integer from about 8 to about 400 and X is selected from

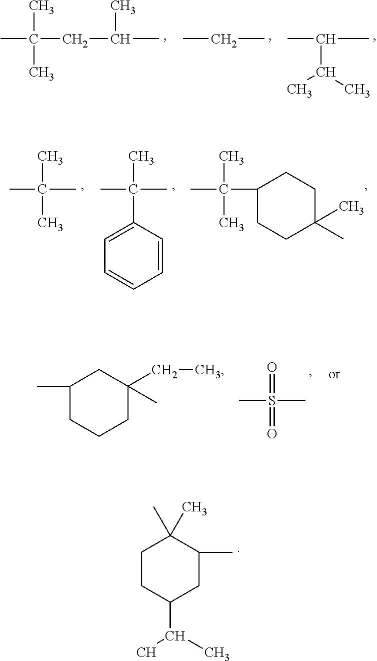

In one particular embodiment, n is an integer between about 20-400 or between about 25-150 or between about 35-100 or between about 38-60. In another embodiment, X is

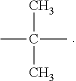

In the first step of the method, the solid epoxy resin or solid phenoxy resin is dissolved in a blend including a protic solvent and an aprotic solvent to form a slurry. As used herein, a “protic solvent” generally refers to a solvent having a hydrogen atom bound to an oxygen atom (as in a hydroxyl group) or a nitrogen atom (as in an amine group), so that it can principally donate protons (W). In one embodiment, the protic solvent may be a C₁-C₆-alkanol, a C₂-C₄-alkandiol, an ether alkanol, water, acetic acid, formic acid, and a mixture thereof.

C₁-C₆-alkanols generally include methanol, ethanol, propanol, isopropanol, n-butanol, sec-butanol, tert-butanol. Preferred C₁-C₄-alkanols include ethanol, n-propanol, isopropanol and n-butanol. Particularly preferred is n-butanol.

C₂-C₄-alkandiols include ethylene glycol or propylene glycol. Ether alkanols include diethylene glycol.

In one embodiment, the protic solvent is a C₁-C₄-alkanol. It has surprisingly been found that the use of a C₁-C₄ alkanol as a solvent in the blend is particularly advantageous in terms of the capability of spray-drying the solid thermoplastic resin and the production of a powder of relatively small average particle size.

In one embodiment, the blend includes about 1 weight percent or more of the protic solvent, based on the total weight of the blend. In other embodiments, the blend includes about 5 weight percent or more, or about 10 weight percent or more, or about20 weight percent or more, or about 30 weight percent or more of the protic solvent, based on the total weight of the blend. In still other embodiments, the blend includes about 99 weight percent or less, or about 90 weight percent, or less or about 80 weight percent or less or about 70 weight percent of the protic solvent, based on the total weight of the blend.

The blend also includes an aprotic solvent. As used herein, “aprotic solvent” refers to a solvent that cannot donate protons. In one embodiment, the aprotic solvent is selected from an aromatic solvent, an alkane solvent, an ether solvent, an ester solvent, acetone, acetonitrile, dimethylformamide and a mixture thereof

In one embodiment, the aromatic solvent is benzene, toluene, xylene (ortho-xylene, meta-xylene or para-xylene), mesitylene, chlorobenzene (MCB), 1,2-dichlorobenzene, 1,3-dichlorobenzene, 1,4-dichlorobenzene, or a mixtures thereof. Preferred aromatic solvents are selected from toluene, xylene (ortho-xylene, meta-xylene or para-xylene), chlorobenzene and a mixture thereof

Alkane solvents include aliphatic hydrocarbons such as pentane, hexane, heptane, cyclohexane, petroleum ether, or a mixture thereof, and halogenated hydrocarbons such as methylene chloride, chloroform, or a mixture thereof.

Ether solvents include open-chained and cyclic ethers, in particular diethyl ether, methyltert-butyl-ether (MTBE), 2-methoxy-2-methylbutane, cyclopentylmethylether, 1,4-dioxane, tetrahydrofuran (THF), 2-methyltetrahydrofuran (CH₃-THF), or a mixture thereof.

Ester solvents include carboxylic esters such as ethyl acetate or butyl acetate.

In one embodiment, the aprotic solvent is selected is selected from toluene, xylene (ortho-xylene, meta-xylene or para-xylene), chlorobenzene, heptane, tetrahydrofuran, 2-methyltetrahydrofuran, methyl-tert-butyl-ether, 1,4-dioxane, ethyl acetate, butyl acetate, acetone, acetonitrile, and a mixture thereof.

In one particular embodiment, the aprotic solvent is an aromatic solvent. It has surprisingly been found that the use of an aromatic solvent as the aprotic solvent in the blend is particularly advantageous in terms of the capability of spray-drying the solid thermoplastic resin and the production of a dry powder of relatively small average particle size.

In another embodiment, the blend includes about 1 weight percent or more of the aprotic solvent, based on the total weight of the blend. In other embodiments, the blend includes about 5 weight percent or more, or about 10 weight percent or more, or about 20 weight percent or more, or about 30 weight percent or more of the aprotic solvent, based on the total weight of the blend. In still other embodiments, the blend includes about 99 weight percent or less, or about 90 weight percent, or less or about 80 weight percent or less or about 70 weight percent of the aprotic solvent, based on the total weight of the blend.

In still other embodiments, the blend includes the protic solvent and aprotic solvent (protic solvent:aprotic solvent) at a weight ratio of about 10:90 (w/w) to about 90:10 (w/w). In still other embodiments, the blend includes the protic solvent to aprotic solvent at a weight ratio of about 25:75 (w/w) to about 75:25 (w/w) or about 30:70 (w/w) to about 70:30 (w/w) or about 40:60 (w/w) to about 60:40 (w/w) or about 45:55 (w/w) to about 55:45 (w/w).

In one embodiment, the solid epoxy resin or solid phenoxy resin is dissolved in the blend to form a slurry containing about 1 weight percent or more of the epoxy or phenoxy resin, based on the total weight of the slurry. In other embodiments, the solid epoxy resin or solid phenoxy resin is dissolved in the blend to form a slurry containing about 3 weight percent or more, or about 5 weight percent or more, or about 7 weight percent or more, or about 10 weight percent or more, or about 15 weight percent or more of the epoxy or phenoxy resin, based on the total weight of the slurry.

In another embodiment, the solid epoxy resin or solid phenoxy resin is dissolved in the blend to form a slurry containing about 20 weight percent or less of the epoxy or phenoxy resin, based on the total weight of the slurry. In other embodiments, the solid epoxy resin or solid phenoxy resin is dissolved in the blend to form a slurry containing about 17 weight percent or less, or about 15 weight percent or less, or about 12 weight percent or less, or about 10 weight percent or less of the epoxy or phenoxy resin, based on the total weight of the slurry.

In yet another embodiment, the solid epoxy resin or solid phenoxy resin is dissolved in the blend to form a slurry containing between about 1 weight percent to about 15 weight percent of the epoxy or phenoxy resin, based on the total weight of the slurry. In other embodiments, the solid epoxy resin or solid phenoxy resin is dissolved in the blend to form a slurry containing between about 2 weight percent to about 13 weight percent, or between about 3 weight percent to about 12 weight percent or between about 5 weight percent to about 10 weight percent of the epoxy or phenoxy resin, based on the total weight of the slurry.

The slurry is then spray-dried to form a dry powder thermoplastic resin composition comprising a plurality of thermoplastic resin (i.e. epoxy resin or phenoxy resin) particles. The term “particle” refers to an individual solid particle of the dry powder thermoplastic resin composition. The individual particles of the dry powder thermoplastic resin composition are preferably physically separated from each other, i.e. the individual particles that constitute the dry powder may be in loose and reversible contact with each other (as opposed to an irreversible link between individual particles).

As used herein, the term “spray-drying” relates to a process that generally involves breaking up of a liquid into small droplets (atomization) and rapidly removing solvent from the droplets in a spray-drying apparatus where there is a strong driving force for evaporation of solvent from the droplets. The strong driving force for solvent evaporation is generally provided by a high surface to mass ratio of the droplets and by maintaining the partial pressure of solvent in the spray-drying apparatus well below the vapor pressure of the solvent at the temperature of the drying droplets. This may be achieved, for example, by maintaining the pressure in the spray-drying apparatus at a partial vacuum or by mixing the droplets with a warm drying gas or a combination of both. As a result of the spray-drying process, particles, preferably dry particles, more preferably in the form of a dry powder composition, are obtained.

Typically, the slurry comprising the solid thermoplastic resin and blend of solvents is first broken up into a plurality of small droplets that may be suspended in a gas or a gas mixture, such as air. The obtained mixture of droplets and gas is typically referred to as ‘spray’ or ‘fog’. The process of breaking up the slurry into droplets is known as ‘atomization’ and may be carried out using any suitable device known in the art (an atomizer). Various types of atomizers are known in the art that are suitable for being used in the method of the present disclosure, such as rotary atomizers, pressure nozzles, two-fluid nozzles, fountain nozzles, ultrasonic nebulizers and vibrating orifice aerosol generators.

In one embodiment, atomization of the slurry results in spherical droplets. As used herein, the term “spherical” comprises not only geometrically perfect spheres, but also more irregular shapes, such as spheroidal, ellipsoid, oval or rounded droplets.

Once the slurry is atomized, the produced spray droplets are mixed with a drying gas allowing the blend of solvents to quickly evaporate in a drying chamber. The rapid evaporation typically results in a cooling effect, so that the dried particles do not reach the drying air temperature which is particularly advantageous if heat sensitive material is dried. The drying chamber may be of any shape and may include one or more chambers. The drying gas may be capable of absorbing, at least partially, the solvent that evaporates from the droplets, and may be introduced into the drying chamber via an inlet, such as a disperser. The disperser may be located in the upper half of the drying chamber, for example, in the vicinity of the atomizer, thus allowing rapid mixing of the drying gas and the droplets. The drying gas stream leaves the drying chamber through an outlet, which may be located at the bottom of the drying chamber.

The characteristics of the drying chamber can be matched with, among others, the atomizer that is used. In order to ensure uniform product quality, the droplets may contact a surface of the drying chamber only when they are sufficiently dry. The dry powder may be collected at the bottom of the drying chamber. In one embodiment, the drying chamber is designed as a cone and the outlet for the drying gas-stream is positioned at the center of the cone where cool and moist air may be removed from the drying chamber. Such a design of the cone and outlet acts as a cyclone separator and leads to an accumulation of the dry powder at the bottom of the drying chamber. Cyclonic separation is preferably used to separate dry particles or fine droplets from the drying gas, in some embodiments without the use of filters, through vortex separation. To this end, a high speed rotating flow is preferably established within a cylindrical or conical container, of the cyclone. Typically, the drying gas flows in a helical pattern from the top (wide end) of the cyclone to the bottom (narrow) end before exiting the cyclone in a straight stream through the center of the cyclone. Larger or denser particles in the rotating stream do not follow the tight curve of the stream, but strike the outside wall and fall to the bottom of the cyclone where they can be collected. Alternatively, a filter, for example. a bag filter, or a combination of a cyclone separator and a filter may be used for separation of the dry powder and drying gas.

Depending on the type of flow, i.e. the relative positions of atomizer and drying gas inlet or, respectively, the relative movement of the spray and the drying gas, several types of spray-drying apparatus' may be distinguished, all of which may be used in the method according to the present disclosure. In one embodiment, the spray-drying apparatus is set up as a co-current flow apparatus (spray and drying gas move into the same directions), as a counter-current flow apparatus (spray and drying gas move into opposite directions) or as a mixed flow apparatus (co-current and counter-current flow combined). In one embodiment, the spray-drying apparatus is a co-current flow apparatus.

Moreover, the spray-drying apparatus may be categorized depending on the type of drying gas cycle that is used. For example, the spray drying apparatus may be an open cycle device (the drying gas that enters the spray drying apparatus through the inlet is exhausted through the outlet into the atmosphere) or a closed cycle spray dryer (the drying gas that enters the spray drying apparatus through the inlet is exhausted through the outlet and is recycled and reused). In one embodiment, the spray drying apparatus is a closed cycle spray dryer.

The drying gas may be any suitable gas or mixture of gases. In one embodiment, an inert gas is used as the drying gas. The inert gas may be, for example nitrogen, nitrogen-enriched air, helium, CO₂ or argon.

In one embodiment, the spray-drying apparatus reduces the residual moisture content of the dry powder thermoplastic resin composition to a desired level, as defined herein, in one pass through the system. If the residual moisture content of the dry powder thermoplastic resin composition after one cycle is higher than desired, the residual moisture content may be further reduced by a second drying stage (or several) until the desired residual moisture content is achieved.

An example of a spray-drying apparatus is shown in FIG. 2, which further illustrates the principle of spray-drying. Slurry input stream (1) is sprayed through a nozzle (2) into a drying gas stream (3) and is vaporized. Upon introduction into the drying gas stream (3), the droplets are cooled down due to the evaporation of solvent from the slurry. Solid spherical particles form, while moisture quickly leaves the droplets. A nozzle is used in order to achieve a sufficiently small droplet size (atomizer) and in order to maximize heat transfer and the rate of solvent evaporation. The solid spherical particles are further dried and separated in a cyclone device (4). The dry spherical particles are cooled and collected in a collection container (5) connected to the cyclone device (4), ready for packaging in different formats.

The final product is collected as described above and is preferably in the form of a dry powder comprising the thermoplastic resin spherical particles as defined herein. In one embodiment, the thermoplastic resin spherical particles have an average particle size of about 150 μm or less, or about 125 μm or less, or about 100 μm or less, or about 75 μm or less, or about 50 μm or less, or about 25 μm or less, or about 20 μm or less, or about 10 μm or less, or about 5 μm or less. In other embodiments, the thermoplastic resin spherical particles have an average particle size of about 1 μm or more, or about 5 μm or more, or about 10 μm or more, or about 15 μm or more, or about 25 μm or more. In still other embodiments, the thermoplastic resin spherical particles have an average particle size of between about 0.5 μm to about 150 μm, or between about 1 μm to about 100 pm, or between about 2 μm to about 50 μm, or between about 3 μm to about 25 μm, or between about 4 μm to about 15 μm.

The dry powder thermoplastic resin composition may be used in a variety of applications/formulations, including, but not limited to, automotive, industrial, construction aerospace, marine, civil engineering, personal protective equipment, coatings, consumer or do-it-yourself products, composite films, plastics, magnetic tape coatings, rigid and flexible packaging coatings, epoxy baking primers, maintenance primers, zinc-rich primers, shop and heavy equipment primers, appliance and coil coating primers, chemical resistant finishes, wood coatings, pipe coatings, flexible modifiers for phenolics or poly (ethylene terephthalates), cellophane, polystyrene, aluminum foil, polycarbonate, cardboard, poly (methyl methacrylate), Kraft paper, canvas duck cloth, “B” stage phenolic impregnated paper, glass fiber cloth, and felt.

### Prophetic Example

Samples with a concentration of about 10% (w/w) phenoxy resin are prepared as starting solutions. 10 g of a solid phenoxy resin is mixed with 90 g of a blend of 50:50 (w/w) n-butanol/toluene solvents. The slurry is stirred for about 10 minutes until a clear solution is obtained. 50 g of slurry is transferred into a 50 ml glass beaker including a magnetic stir bar. The slurry is stirred continuously during the spray drying run. The beaker is sealed with Parafilm foil to prevent any solvent from evaporating during the drying process.

The slurry is spray-dried in a closed-cycle spray dryer. Nitrogen is used as the drying gas. The drying gas flow rate is about 140 L/min resulting in an the inside pressure of about 60 mbar. The laminar drying gas flow and piezoelectric atomization leads to a gentle evaporation. The inlet temperature is varied between 20°, 25°, 30°, 35° and 40° C. Depending on the selected spray cap size, the outlet temperature and the spray head temperature are varied accordingly. A spray rate of 60% is used. After reaching the inlet temperature, a blend of a 50:50 (w/w) ratio of n-butanol/toluene is sprayed in order to stabilize the outlet temperature. The slurry is then sprayed and the dry powder collected in an electrostatic particle collector. The morphology and particle size of the solid phenoxy resin particles of the dry powder is determined using a scanning electron microscope (SEM) and can be found to be spherical particles having an average particle size of about 10 μm. The moisture content is determined by an infrared Moisture Analyzer B-302 and can be found to be about 1% (w/w).

From the foregoing, it will be understood that numerous modifications and variations can be effectuated without departing from the true spirit and scope of the novel concepts of the present invention. It is to be understood that no limitation with respect to the specific embodiments illustrated and described is intended or should be inferred.

What is claimed is:

1. A method of forming a dry powder thermoplastic resin composition, the method comprising:
dissolving a solid thermoplastic resin selected from the group consisting of a solid epoxy resin and a solid phenoxy resin in a blend of a protic solvent and an aprotic solvent to form a slurry; and
spray drying the slurry to form the dry powder thermoplastic resin composition.

2. The method of claim 1, wherein the solid epoxy resin comprises a bisphenol A epoxy resin, a bisphenol F epoxy resin, a bisphenol AF based epoxy resin, an o-cresol novolak epoxy resin, a phenol novolak epoxy resin, a modified phenol epoxy resin, a naphthalene epoxy resin, a triphenolmethane epoxy resin, an alkyl modified triphenolmethane epoxy resin, a triazine nucleus-containing epoxy resin, a dicyclopentadiene epoxy resin, a glycidylamine epoxy resin, a biphenyl epoxy resin, a biphenylaralkyl epoxy resin, a hydrogenated bisphenol A epoxy resin, an aliphatic epoxy resin, a stilbene epoxy resin, a triglycidyl ether of trisphenol-methane, an isocyanate-modified bisphenol A based epoxy resin, an isocyanate-modified bisphenol F based epoxy resin, an isocyanate modified bisphenol AF based epoxy resin, an isocyanate modified bisphenol A novolak epoxy resins, a bisphenol F novolak epoxy resin, a bisphenol AF novolak epoxy resin, or a combination thereof.

3. The method of claim 1, wherein the solid phenoxy resin has a structural formula 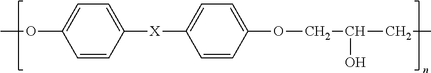
where n is an integer from about 8 to about 400 and X is selected from

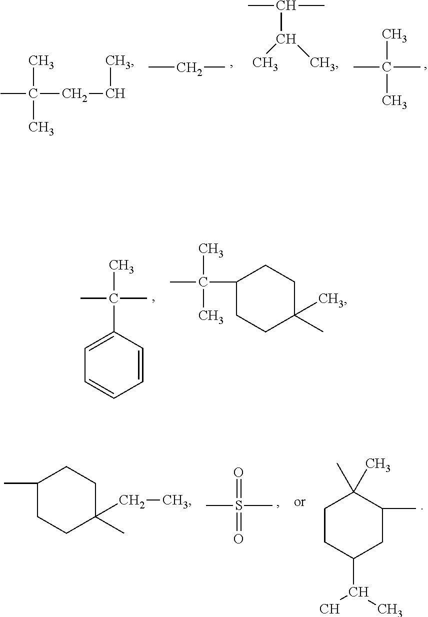

4. The method of claim 1, wherein the protic solvent is selected from a C₁-C₆-alkanol, a C₂-C₄-alkandiol, an ether alkanol, water, acetic acid, formic acid, and a mixture thereof.

5. The method of claim 4, wherein the aprotic solvent is selected from an aromatic solvent, an alkane solvent, an ether solvent, an ester solvent, acetone, acetonitrile, dimethylformamide and a mixture thereof.

6. The method of claim 1, wherein the blend includes the protic solvent and aprotic solvent at a weight ratio (protic solvent:aprotic solvent) of about 30:70 (w/w) to about 70:30 (w/w).

7. The method of claim 6, wherein the slurry contains between about 5 weight percent to about 10 weight percent of epoxy or phenoxy resin, based on the total weight of the slurry.

8. The method of claim 1, wherein the solid phenoxy resin is obtained by a condensation reaction between a dihydric phenol compound and epichlorohydrin, or by a polyaddition reaction between a dihydric phenol compound and a difunctional epoxy resin.

9. The method of claim 8, wherein the solid phenoxy resin is obtained in the presence of a reaction solvent.

10. The method of claim 9, wherein the reaction solvent comprises dioxane, tetrahydrofuran, acetophenone, N-methylpyrrolidone., dimethyl sulfoxide, N,N-dimethylacetamide, sulfolane or toluene.

11. The method of claim 1, wherein the slurry is spray-dried in a closed cycle spray drying apparatus.

12. A dry powder thermoplastic resin composition obtained from the method of claim 1, wherein the dry powder thermoplastic resin composition comprises a plurality of particles selected from epoxy resin particles and phenoxy resin particles.

13. The dry powder thermoplastic resin composition of claim 12, wherein the plurality of particles have an average particle size of about 150 μm or less.

14. The dry powder thermoplastic resin composition of claim 13, wherein the average particle size is about 20 μm or less.

15. The method of claim 12, wherein the dry powder thermoplastic resin composition has a residual moisture content of about 2% (w/w) or less.

16. Use of the dry powder thermoplastic resin composition of claim 12 in a coating, or an adhesive or a plastic, or a composite, or an electronic component.

17. A method of forming a dry powder thermoplastic resin, the method comprising:
dissolving a solid thermoplastic resin selected from a solid phenoxy resin in a blend of a protic solvent and an aprotic solvent to form a slurry; and
spray drying the slurry to form the dry powder thermoplastic resin composition, wherein the dry powder thermoplastic resin composition comprises a plurality of phenoxy resin particles having an average particle size of between about 3 μm to about 25 μm and a residual moisture content of from about 0.01% (w/w) to about 1.5% (w/w) and wherein the spray drying is performed in a closed cycle spray dryer.

18. A method to form a powdered epoxy or phenoxy resin, the method comprising:
providing a solid epoxy or phenoxy resin with an average molecular weight of at least about 1000 Dalton;
dissolving the solid epoxy or phenoxy resin in a blend of an alcohol solvent and an aprotic solvent to form a resulting solution, wherein the alcohol solvent has two to six carbon atoms, the blend has a weight ratio of the alcohol solvent to the polar aprotic solvent of between about 30:70 to about 70:30, and the resulting solution has between about1 weight percent to about 10 weight percent epoxy or phenoxy resin, based on the total weight of the resulting solution; and
spray-drying the resulting solution in a closed-cycle spray drier to form the powdered epoxy or phenoxy resin.

19. The method of claim 18, wherein the solid epoxy or phenoxy resin has an average molecular weight of at least about 10,000 Dalton.

20. The method of claim 18, wherein the solid epoxy or phenoxy resin has an average molecular weight of at least about 30,000 Dalton.

21. The method of claim 18, wherein the solid epoxy or phenoxy resin has an average molecular weight of at least about 50,000 Dalton.

22. The method of claim 18, wherein the ratio of the alcohol solvent to the aprotic solvent is between about 40:60 to about 60:40.

23. The method of claim 18, wherein the ratio of the alcohol solvent to the aprotic solvent is about 50:50.

24. The method of claim 18, wherein the alcohol solvent is selected from a group consisting of ethanol, propanol, isopropanol, butanol, pentanol, and hexanol.

25. The method of claim 24, wherein the alcohol solvent is butanol.

26. The method of claim 18, wherein the aprotic solvent is selected from a group consisting of methyl ethyl ketone, methyl isobutyl ketone, toluene, xylene, dichloromethane, and tetrahydrofuran.

27. The method of claim 18, wherein the aprotic solvent is toluene.

28. The method of claim 18, wherein the resulting solution contains between about 5 weight percent to about 10 weight percent epoxy or phenoxy resin.

29. The method of claim 18, wherein the powdered epoxy or phenoxy resin comprises no more than about 5 weight percent residual solvent, based on the total weight of the powdered epoxy or phenoxy resin.

30. The method of claim 18, wherein the powdered epoxy or phenoxy resin comprises no more than about 1.5 weight percent residual solvent, based on the total weight of the powdered epoxy or phenoxy resin.

31. The method of claim 18, wherein the powdered epoxy or phenoxy resin comprises no more than about 0.5 weight percent residual solvent, based on the total weight of the powdered epoxy or phenoxy resin.

32. The method of claim 18, wherein the powdered epoxy or phenoxy resin comprises no more than about 0.3 weight percent residual solvent, based on the total weight of the powdered epoxy or phenoxy resin.

33. The method of claim 18, wherein the powdered epoxy or phenoxy resin has an average particle size of no more than about 20 μm.

34. The method of claim 18, wherein the powdered epoxy or phenoxy resin has an average particle size of no more than about 12 μm.

35. A powdered epoxy or phenoxy resin, comprising:
no more than about 5 weight percent residual solvent; and
at least about 95 weight percent solid epoxy or phenoxy resin, wherein the solid epoxy or phenoxy resin has an average molecular weight of at least about 1000 Dalton; and
an average particle size of no more than about 20 μm and wherein the weight percent is based on the total weight of the powdered epoxy or phenoxy resin.

36. The powdered epoxy or phenoxy resin of claim 35, wherein the powdered epoxy or phenoxy resin comprises no more than about 1.5 weight percent residual solvent.

37. The powdered epoxy or phenoxy resin of claim 35, wherein the powdered epoxy or phenoxy resin comprises no more than about 0.5 weight percent residual solvent.

38. The powdered epoxy or phenoxy resin of claim 35, wherein the powdered epoxy or phenoxy resin comprises no more than about 0.3 weight percent residual solvent.

39. The powdered epoxy or phenoxy resin of claim 35, wherein the solid epoxy or phenoxy resin has an average molecular weight of at least about 10,000 Dalton.

40. The powdered epoxy or phenoxy resin of claim 35, wherein the solid epoxy or phenoxy resin has an average molecular weight of at least about 30,000 Dalton.

41. The powdered epoxy or phenoxy resin of claim 35, wherein the solid epoxy or phenoxy resin has an average molecular weight of at least about 50,000 Dalton.

42. The powdered epoxy or phenoxy resin of claim 35, wherein the solid epoxy or phenoxy resin has an average particle size of no more than about 12 μm.
